(19) United States
(12) Patent Application Publication
(10) Pub. No.: US 2026/0149392 A1
(43) Pub. Date: May 28, 2026

(54) OPERATION OF SWITCHING ELEMENTS OF AN INVERTER

(71) Applicant: Siemens Aktiengesellschaft, München (DE)

(72) Inventors: Norbert Benesch, Heroldsberg (DE); Bernd Wedel, Möhrendorf (DE)

(73) Assignee: Siemens Aktiengesellschaft, München (DE)

(21) Appl. No.: 19/121,722

(22) PCT Filed: Aug. 29, 2023
(86) PCT No.: PCT/EP2023/073598

§ 371 Date: Apr. 16, 2025

(30) Foreign Application Priority Data
Oct. 17, 2022 (EP) 22201841.8

(51) Int. Cl. H02M 7/5387; H02M 1/00; H02M 1/12

(52) U.S. Cl. CPC H02M 7/53875; H02M 1/0009; H02M 1/126

(57) ABSTRACT

The invention relates to a method for operating switching elements (24) of an Inverter (20) which is electrically coupled to a multiphase alternating voltage (16), wherein the inverter has at least one series circuit (22) which consists of the switching elements (24) for each of the phases of the multiphase alternating voltage in order to electrically couple the multiphase alternating voltage to a direct voltage intermediate circuit (28) which is connected to the inverter by applying switching signals (40) to the switching elements of the series circuits, wherein the switching signals are determined on the basis of a clock signal using pulse width modulation, wherein, depending on phase currents and an intermediate circuit direct voltage based on a field-oriented controller (36), a space vector is determined and the switching signals are determined depending on the space vector and using phase target voltages. According to the invention, a damping space vector is superimposed on the space vector to determine the switching signals and is determined depending on the phase currents such that phase positions of the phase target voltages are shifted by a predetermined phase value with respect to at least one predetermined frequency which is greater than the fundamental vibration.

The invention relates to a method for operating switching elements of an inverter which is electrically coupled to a multiphase alternating voltage of an alternating voltage grid via an alternating voltage-side filter, wherein the inverter has at least one series circuit comprised of the switching elements for each of the phases of the multiphase alternating voltage in order to electrically couple the multiphase alternating voltage to a direct voltage intermediate circuit connected to the inverter by applying switching signals to the switching elements of the series circuits, wherein the switching signals are ascertained on the basis of a clock signal using pulse width modulation for which purpose the phase currents of phases of the multiphase alternating voltage and an intermediate circuit direct voltage are detected, wherein a clock period of the clock signal is smaller than an oscillation period of a fundamental oscillation of the phase voltages, wherein a space vector is ascertained as a function of the detected phase currents and the detected intermediate circuit direct voltage based on a field-oriented regulator and the switching signals are determined as a function of the space vector by means of space vector modulation and using target phase voltages. Furthermore, the invention relates to a control facility for operating switching elements of an inverter which is electrically coupled to a multiphase alternating voltage of an alternating voltage grid via an alternating voltage-side filter, wherein the inverter has at least one series circuit comprised of the switching elements for each of the phases of the multiphase alternating voltage, wherein the control facility is embodied to apply switching signals to the switching elements of the series circuits in order to electrically couple the multiphase alternating voltage to a direct voltage intermediate circuit connected to the inverter, to ascertain the switching signals on the basis of a clock signal using pulse width modulation for which purpose the phase currents of phases of the multiphase alternating voltage and an intermediate circuit direct voltage are detected, wherein a clock period of the clock signal is smaller than a oscillation period of a fundamental oscillation of the phase voltages, and to ascertain a space vector as a function of the detected phase currents and the detected intermediate circuit direct voltage based on a field-oriented regulator and to determine the switching signals as a function of the space vector by means of space vector modulation and using target phase voltages. Finally, the invention also relates to an energy converter for electrically coupling a multiphase electrical alternating voltage of an alternating voltage grid to a direct voltage intermediate circuit, with an inverter, the inverter having at least one series circuit comprised of the switching elements for each of the phases of the multiphase alternating voltage, wherein a respective series circuit is electrically coupled to the direct voltage intermediate circuit and a respective center terminal of a respective series circuit can be electrically coupled to a respective phase of the multiphase alternating voltage, an alternating voltage-side filter for electrically coupling the inverter to the multiphase alternating voltage, and a control facility for operating the switching elements of the inverter.

Energy converters with inverters, control facilities therefor and methods for operating switching elements of inverters are extensively known in the prior art, so that there is no need for separate published evidence of this. Nowadays, electrical energy converters, also called electrical energy transformers, are used in the form of so-called static energy converters, i.e., unlike dynamic energy converters, they do not need to have any mechanically movable, in particular rotatable, parts for the purpose of energy conversion. Static energy converters are generally embodied as clocked electrical energy converters and, for this purpose, have at least one inverter with switching elements that are suitably interconnected and, for example, connected to phase terminals, phases for short, of a multiphase alternating voltage and at least partially to a direct voltage intermediate circuit in order to electrically couple the multiphase alternating voltage to the direct voltage intermediate circuit, so that the desired conversion function of the energy converter can be achieved by operating the switching elements in a suitable switching mode,

Herein, a switching element within the meaning of this disclosure is preferably a controllable electronic switching element, for example a controllable electronic semiconductor switch, such as a transistor, thyristor, combination circuits thereof, preferably with parallel-connected freewheeling diodes, a gate-turn-off thyristor (GTO), an insulated-gate bipolar transistor (IGBT), combinations thereof or the like. In principle, the switching element can also be formed by a field-effect transistor, in particular a metal-oxide-semiconductor field-effect transistor (MOSFET).

To provide the desired energy conversion functionality, the switching elements are operated in switching mode. In relation to a semiconductor switch in the manner of a transistor, this means that, in a switched-on switching state, very low electrical resistance is provided between the terminals of the transistor forming a switching path, so that a high current flow is possible with a very low residual voltage. In a switched-off switching state, on the other hand, the transistor's switching path is highly resistive, i.e., it provides high electrical resistance, so that even with a high electrical voltage applied to the switching path, there is substantially no current flow or only a very low, in particular negligible, current flow. This differs from linear operation with transistors, which, however is not generally used with clocked energy converters.

It can be provided that the direct voltage intermediate circuit is provided by a direct voltage grid and/or the multiphase alternating voltage is provided by a multiphase alternating voltage grid, which can, for example, be a public power supply grid. The multiphase alternating voltage is preferably a three-phase alternating voltage. However, depending on the grid, it can also be a two-phase alternating voltage, a four-phase alternating voltage, a five-phase alternating voltage, or the like. The number of phases of the multiphase alternating voltage generally depends on the application and is not limited.

The switching elements of the inverter are coupled to the control facility. The coupling is preferably embodied such that each of the switching elements can be controlled individually. The control facility can be embodied as an electronic circuit that provides the corresponding control signals for the switching elements, so that the desired switching mode of the switching elements can be realized. In addition to electronic components for the predeterminable provision of the control signals, the electronic circuit can also comprise at least one program-controlled computing unit in order to be able to provide the desired function of the control facility. Of course, the control facility can also consist solely of the computing unit.

The control facility is embodied to operate the switching elements in switching mode in such a way that the energy converter provides the specified energy conversion functionality. Furthermore, the control facility is embodied to set phase currents of the multiphase alternating voltage in a prespecifiable manner. The control facility therefore provides a regulation functionality by means of which the phase currents can be set in a prespecifiable manner. This makes it possible to regulate the phase current at a respective phase in a prespecifiable manner. Suitable current sensors or the like can be used to detect the phase currents, for example. The current sensors can be comprised by the energy converter. However, it can also be provided that the energy converter has terminals for the current sensors which are, for example, comprised by the corresponding electrical alternating voltage grid to which the regulated phase currents are to be applied.

Usually, a suitable regulation functionality is provided to regulate the phase currents. A frequently used option for providing the phase currents uses, for example, a field-oriented regulator using space vector modulation, which—depending on the design—is sometimes also referred to as vector regulation and, for the three-phase case, is based on the use of d/q transformation, also called Park transformation. Park transformation is used to transform three-phase variables of the electrical three-phase machine into a two-axis coordinate system with reference axes d and q. This enables vector control or vector regulation to be realized in which space vector representations can be used to set the operating states of the inverter. The d/q transformation is related to Clarke transformation and differs from the latter in particular in that the d/q-coordinate system of d/q transformation rotates with a rotor of the three-phase electrical machine during stationary operation. In this case, a respective value pair composed of values d, q can then represent a time-constant variable for this operating state. The field-oriented regulator can determine target phase voltages for each of the phases of the multiphase alternating voltage. The switching signals can then be ascertained as a function of the target phase voltages as part of pulse width modulation.

Inverters that are used as frequency converters, in particular grid-tied inverters, and are accordingly connected to a multiphase alternating voltage grid, are usually connected via grid-side filters, in particular LCL filters, to smooth the phase currents or to reduce the harmonic content of phase voltages of the multiphase alternating voltage and/or line-bound interference to such an extent that the applicable grid guidelines and/or grid standards are complied with in each case. Such filters generally have a combination of inductances and capacitors. This leads to oscillating systems that can develop resonance. Therefore, damping elements are required to avoid very large resonance peaks in individual frequency ranges in the resonant frequency range. Traditionally, passive ohmic resistors are integrated into a filter structure of the filter as damping elements, or parasitic ohmic properties of components are used for passive damping.

However, the disadvantages of this proven damping technology are the resulting power loss, which leads to reduced efficiency and the associated additional technical effort required to dissipate heat loss, additional installation space for the damping elements and the associated additional costs, and finally also a reduced filtering effect of the filter due to the passive damping elements in the actually desired frequency range of the filter, resulting in Increased costs and installation space.

The invention is based on the object of developing generic methods, control facilities and energy converters in order to reduce the need for damping elements in filters with inductances and capacitances.

As a solution, the invention proposes a method, a control facility and an energy converter according to the independent claims.

Advantageous developments emerge from features of the dependent claims.

With regard to a generic method, the invention in particular proposes that the space vector is ascertained solely as a function of the detected phase currents and the detected intermediate circuit direct voltage and that a damping space vector is additionally superimposed on the space vector for determining the switching signals, which damping space vector is ascertained as a function of a damping signal, which is in turn determined as a function of the phase currents, so that phase positions of the target phase voltages are shifted by a specified phase value with respect to at least one specified frequency which is greater than the fundamental oscillation.

With regard to a generic control facility, the invention in particular proposes that the control facility is further embodied to ascertain the space vector solely as a function of the detected phase currents and the detected intermediate circuit direct voltage and additionally to superimpose a damping space vector on the space vector for determining the switching signals, which damping space vector is ascertained as a function of a damping signal, which is in turn determined as a function of the phase currents, so that phase positions of the target phase voltages are shifted by a specified phase value with respect to at least one specified frequency which is greater than the fundamental oscillation.

With regard to a generic energy converter, the invention in particular proposes that the control facility is embodied according to the invention.

The Invention is, Inter alia, based on the idea that damping elements can be reduced by the use of a regulation structure with filtering of the target voltage calculated before the field-oriented regulator taking into account a damping signal. The regulation structure achieved in this way can, for example, have a digital filter, wherein, however, preferably no band-stop filter characteristics are configured, not even as a high-pass or low-pass filter. This design avoids the fact that, although stop filter characteristics with a respective stop range could avoid excitation of a resonance point, resulting regulation characteristics would simultaneously lose their effect in the event of external interference excitation in the frequency range in question. Shifting the phase positions of the phase currents by the specified phase value with respect to the at least one specified frequency makes it possible to reduce, or even prevent, any excitation of alternating voltage-side resonance, without the need to provide damping elements. As a result, It is in particular possible to reduce or avoid the disadvantages associated with damping elements.

Generally, grid-side resonant frequencies can be excited or amplified in conjunction with the alternating voltage-side filter by the clocked mode of the inverter. A grid-side resonant frequency is generally greater than a frequency of the fundamental oscillation of the alternating voltage. The specified frequency can also be a frequency range that is above the frequency of the fundamental oscillation. If a resonance effect occurs, it is indicated by a corresponding amplitude in the phase currents at this frequency. Such resonant frequencies can be greater and/or smaller than a frequency corresponding to the clock period. The control facility is preferably embodied to perform the phase shift for one or more specified frequencies or frequency ranges. In particular, it can be provided that the control facility does not substantially shift the phase for the frequency of the fundamental oscillation or a range comprising the frequency of the fundamental oscillation.

The damping signal is an electrical signal that can be linked to the space vector and can also be formed by one or more electrical signals. For example, at least partial superimposition, In particular addition, can be provided.

The damping signal can have a separate value for each phase of the alternating voltage. Depending on the damping signal, the damping space vector is determined by means of a damping unit of the control facility. The damping unit can, for example, have a digital filter. The damping space vector is preferably provided as a Clarke transform. Superimposition with the space vector can take place by linking, which can, for example, comprise vector addition or the like. A damping space vector can, for example, be assigned to a single resonant frequency. The damping space vector can in tum be formed from a superimposition of a plurality of individual frequency-specific damping space vectors. This allows a plurality of resonant frequencies that occur to be treated substantially together or simultaneously. However, no settings need to be made for this in the invention. In principle, the invention makes it possible to adapt to any resonant frequencies that occur and to suppress them.

Herein, an advantageous system property can be to reduce a dependency of filter resonance points, for example with respect to an increase in frequency and amplitude, on properties of the alternating voltage grid, in particular with respect to complex grid impedance at the terminal. In the case of an electrical alternating voltage grid, such as the public power supply grid, complex grid impedance can vary, for example if other electrical facilities that are also electrically coupled to the alternating voltage grid are changed. This means that the resonance points of the alternating voltage grid can change slowly or abruptly during operation and are accordingly generally largely unknown. In addition, further grid filters from further inverters can also be connected to the same terminal of the alternating voltage grid and lead to additional or changed resonance points in the overall system of the alternating voltage grid, in particular as a function of their operation.

The invention therefore provides a method and a control facility for active damping, in particular of an LC(L) grid filter, which is capable of ensuring the necessary damping effect for a variable position of one or more resonance points over a wide band, comparable to real ohmic resistance as a damping element. The invention is therefore particularly suitable for filters designed in the manner of an LCL filter. Herein, the invention avoids the need to measure an electrical voltage at the filter or an electrical current at a filter branch and to take these into account when ascertaining the space vector. In particular, no filter electrical variables on the filter side, such as, for example, a filter current, an electrical voltage, in particular in the area of the filter, or the like, need to be detected. The invention does not require such measurements. It is based on the use of the phase currents that are already available for the realization of the field-oriented regulator. Neither is there any need to provide a frequency-selective filter in the manner of a band-stop filter, which would be Inappropriate anyway due to a notch frequency that has to be set as a function of the grid resonance subject to the variation.

The invention can be realized using both analog and digital technology. In this respect, the control facility can have an analog and/or digital hardware circuit for realizing the function according to the invention. In principle, the function could also be realized with a program-controlled computing unit. However, a hardware circuit is preferable due to the generally faster response time compared to a program-controlled computing unit. The invention can, for example, be realized in the manner of an ASIC, an FPGA or the like. In particular, the invention can also be retrofitted to existing control facilities or control facility designs with little effort. If a computing unit is provided, the invention can at least partially be covered by the computer program.

The invention is in particular suitable for use in grid inverters, such as those disclosed In EP 3 576 284A1. However, the use of the invention is not limited to this; it can, inter alia, also be used if an electrical machine is electrically coupled to the inverter instead of the multiphase alternating voltage. The invention can particularly advantageously be combined with PWM in the manner of a discontinuous modulation method.

Therefore, according to the invention only broadband filters need to be used and in particular there is no need for band-stop filters that have to be tuned to the current filter resonance and thus have to be continuously adapted to changing grid parameters. This makes it possible, for example, to work with a fixed regulator setting with a widely varying grid impedance range.

In summary, the invention can in particular be characterized by one or more of the following features:
active filter damping without additional measured variables, but solely with the aid of detected Inverter currents or phase currents in the phases of the multiphase alternating voltage grid.
extension of the current loop with a digital phase-compensating filter, in particular a higher-order lead-lag element or a modified all-pass filter with a suitable phase response,
no model or observer is introduced into the field-oriented regulator, wherein such a component would require at least partial knowledge of parameters of the multiphase alternating voltage grid and would therefore reduce the overall robustness of the regulator with regard to fluctuations in these unknown parameters,
integration of the regulator, preferably the entire regulator, into an integrated circuit, for example an ASIC or the like, which preferably includes the detection and processing of measured values, a current regulator, but at least a proportional regulator, a phase-compensating filter, in particular a digital filter, for example a 2^{nd} order filter, a calculation of the switching signals in the modulator for space vector modulation,
the use of integrating actual current value detection, for example in the manner of a sigma-delta measurement for suppressing radio-frequency interfering frequency components in the current measurement, and/or
the use of flat modulation to minimize power loss and to compensate the resulting increased dead time by a higher-order digital filter in the modulator,

It is further proposed that the phase positions exhibit lead shifting. This enables good damping of the at least one resonance of the alternating voltage grid to be achieved. The lead of the phase position is preferably selected in such a way that response times of the control facility, in particular with respect to the field-oriented regulator, space vector modulation and/or the detection of the phase currents, are taken into account. Sufficient phase reserve should be taken into account during design so that damping of resonant frequencies can be reliably achieved even with resonant frequencies or stiff alternating voltage grids.

Furthermore, it is proposed that the damping signal is provided by means of a damping unit, which determines the at least one specified frequency and which evaluates the phase currents and ascertains the phase value as a function of the evaluation. The damping unit Is, for example, part of the control facility. The damping unit can provide a filter functionality that realizes the shifting of the phase, in particular the lead of the phase. The damping signal is preferably provided for a plurality of, in particular all, resonant frequencies or one or more frequency ranges. Herein, account can be taken of the fact that the resonant frequency can be a function of the interaction of the alternating voltage grid with the filter. Therefore, the damping signal does not need to be provided permanently during operation as intended. It can be provided that the phase currents are evaluated and as a function thereof it is determined whether the inverter's operating state is in the range of a resonant frequency. If such an operating state is not present, it can be provided that the damping signal is deactivated. This development can reduce or even avoid dead time in the regulator.

According to one development, it is proposed that the detected phase currents are digitized by means of an integrating measuring method. The integrating measuring method can, for example, be a sigma-delta method, an oversampling method or the like. In this development, at least partial digital signal processing is provided. The sigma-delta method represents an integrating method for detecting currents, so that, for example, harmonics can be reduced during detection; these can for example, arise when sampling a signal value that is provided by the respective current sensor when detecting the respective phase current. For example, a 1-bit signal current can be provided. However, in principle, a comparable integrating method can also be used for digitization instead of the sigma-delta method. In particular, a measuring interval with a very small dead time, in particular no dead time, can be achieved.

Preferably, a digitization clock period is at least a factor of 100, preferably at least a factor of 1000, smaller than the clock period of the clock signal. The digitization clock period corresponds to a sampling rate when digitizing the signal value. The fact that the digitization clock period is significantly smaller than the clock period of the clock signal enables accurate and reliable digitization to be achieved despite the integrating sampling method.

According to one development, it is proposed that discontinuous pulse width modulation is used as pulse width modulation. With discontinuous pulse width modulation, switching losses of the switching elements can, for example, be reduced. In particular, discontinuous pulse width modulation is suitable for use in energy converters that are used to convert large amounts of electrical power.

It is further proposed that averaging is performed for the detected phase currents, which averaging extends over at least two clock periods of the clock signal. This can further improve the performance of the method according to the invention. This embodiment can, for example, be particularly advantageously combined with discontinuous pulse width modulation. It is possible that measured values can be detected symmetrically in relation to the pulse width modulation, in particular the clock signal.

It is further proposed that the phase currents are detected in respective detection periods, wherein a respective one of the detection periods extends over a respective clock period of the clock signal. This makes it possible to use detected currents of the phase currents directly for the subsequent determination of the switching signals. The detection of the phase currents advantageously extends over a respective clock period of the clock signal of the pulse width modulation.

In addition, it is proposed that the phase voltages of the multiphase alternating voltage are detected before the space vector is determined, wherein the field-oriented regulator is initialized as a function of voltage signals corresponding to the phase voltages. In particular if the inverter is a grid inverter, this enables the field-oriented regulator to be synchronized with the alternating voltage.

It is further proposed that a transfer function is used to provide the damping signal, which transfer function substantially has an amplification factor in a range of 1, at least in the range of the at least one specified frequency. The resonant frequency results, inter alia, from the interaction of the alternating voltage grid providing the alternating voltage with the filter, also called the grid filter, and possibly further connected electrical facilities. At least within the range, the control facility provides the transfer function, which is used to determine the damping signal as a function of the phase currents. The damping signal can preferably be determined solely as a function of the phase currents. An amplitude is therefore preferably changed as little as possible when determining the damping signal. In contrast, for this purpose, a phase position of the damping signal is determined in a suitable manner, so that the desired preferable lead in the phase position can be achieved as part of the superimposition with the space vector.

Preferably, the control facility has a phase shifter circuit to provide the damping signal. The electronic phase shifter circuit enables the desired phase shift to be easily achieved using hardware. The phase shifter circuit can be provided at least partially by the damping unit. A phase shifter circuit is an electronic circuit that shifts the phase of an electrical oscillation. Electronic delay lines or delay circuits can be used for lagging phase shifts. In the case of leading phase shifts, phase locked loops (PLLs), or the like can be used, in particular for periodic signals. The phase shifter circuit enables a desired phase position to be set quickly and precisely. In particular, the phase shifter circuit can be embodied as a lead-lag element.

For cases and situations that may arise during the method and which are not explicitly described here, it can be provided according to the method that an error message and/or a request for user feedback is output and/or a default setting and/or a predetermined initial state is set.

The advantages and effects described for the method according to the invention obviously also apply equally to the control facility according to the invention and the energy converter according to the invention and vice versa. In this respect, features of the method can also be formulated as apparatus features and vice versa.

The features and feature combinations mentioned above in the description and the features and feature combinations mentioned below in the description of the figures and/or only shown in the figures can be used not only in the indicated combination in each case, but also in other combinations, without departing from the scope of the invention.

The exemplary embodiments explained below are preferred embodiments of the invention. The features and feature combinations described above in the description and also the features and feature combinations mentioned in the description of exemplary embodiments and/or only shown in the figures can be used not only in the indicated combination in each case, but also in other combinations. Thus, embodiments which are not explicitly shown and explained in the figures, but which result from the explained combinations and can be produced from separate feature combinations are also comprised by the invention or are to be considered to be disclosed. The features, functions and/or effects illustrated by means of the exemplary embodiments can each represent individual features, functions and/or effects of the invention which are in each case to be considered independently of one another and which in each case also develop the invention independently of one another. Therefore, the exemplary embodiments are also intended to comprise combinations other than those in the embodiments explained. In addition, the embodiments described can also be supplemented by further features, functions and/or effects of the invention.

In the figures, identical reference symbols denote identical features or functions.

It is shown in:

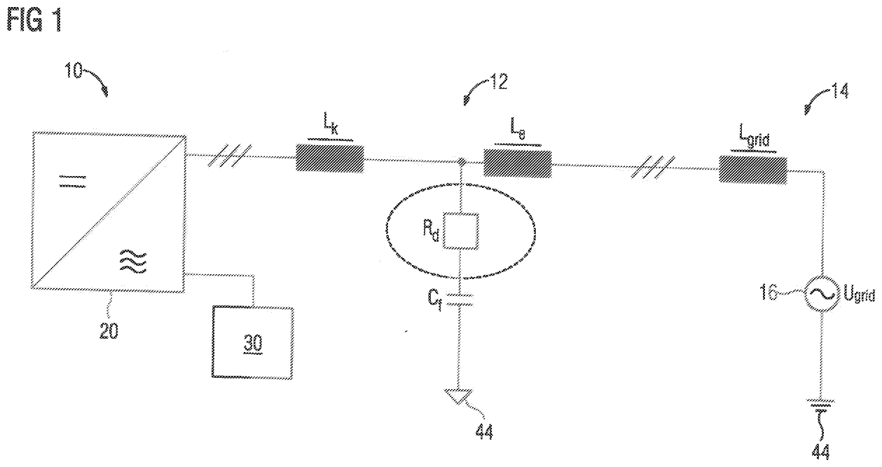

FIG. 1 a schematic circuit diagram of an energy converter connected to an alternating voltage grid, which has an inverter, a filter for electrically coupling the alternating voltage grid and a control facility;

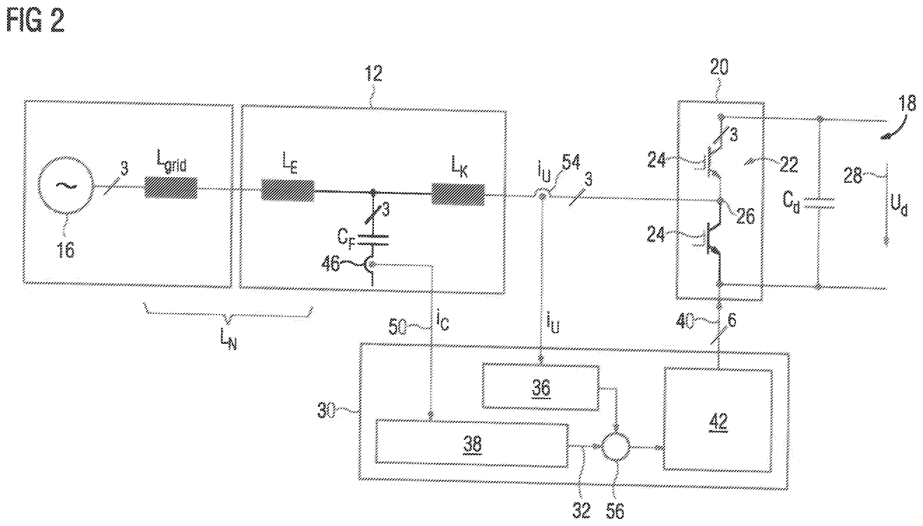

FIG. 2 a schematic circuit diagram as shown in FIG. 1 in which the filter is embodied as a T-filter and a current sensor detects an electrical current in a branch of the T-filter;

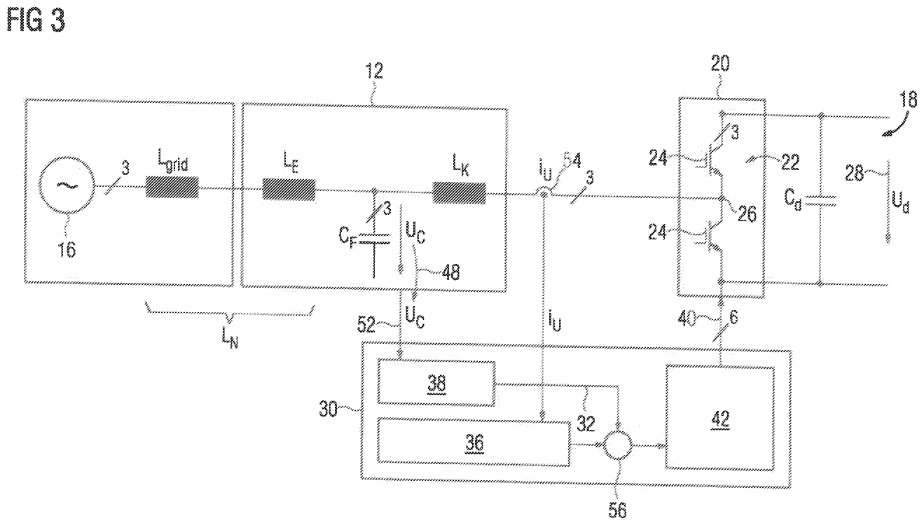

FIG. 3 a schematic circuit diagram as shown in FIG. 2 in which an electrical filter voltage is detected instead of the electrical current;

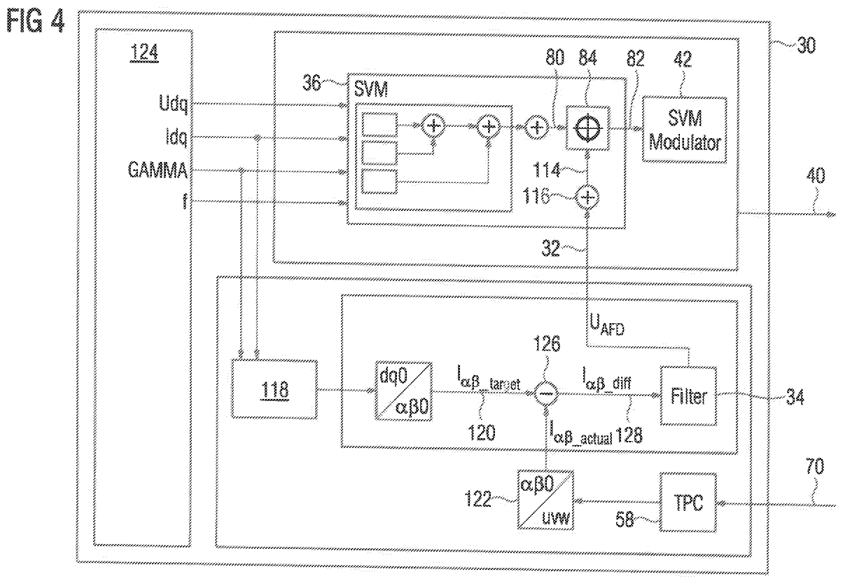

FIG. 4 a schematic block circuit diagram of a field-oriented regulator and space vector modulation of the control facility in which a space vector is additionally processed by means of a phase shifter circuit as an active damping circuit;

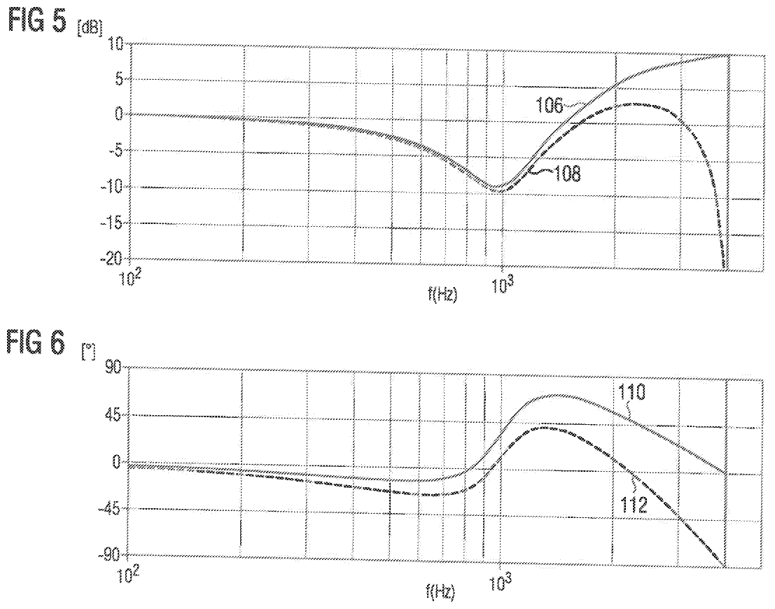

FIG. 5 a schematic diagram of a frequency-dependent gain curve of a transfer function of the damping circuit in FIG. 4;

FIG. 6 a schematic diagram of a frequency-dependent phase curve of the transfer function of the damping circuit in FIG. 4;

FIG. 7 a schematic diagram of a frequency-dependent gain curve of the open loop in FIG. 4 without the active damping circuit;

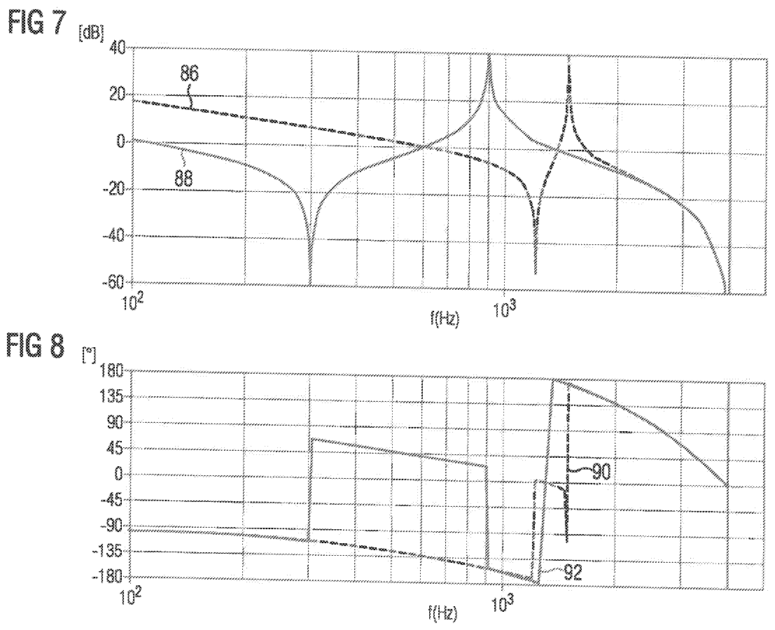

FIG. 8 a schematic diagram of a frequency-dependent phase curve of the open loop in FIG. 4 without the active damping circuit;

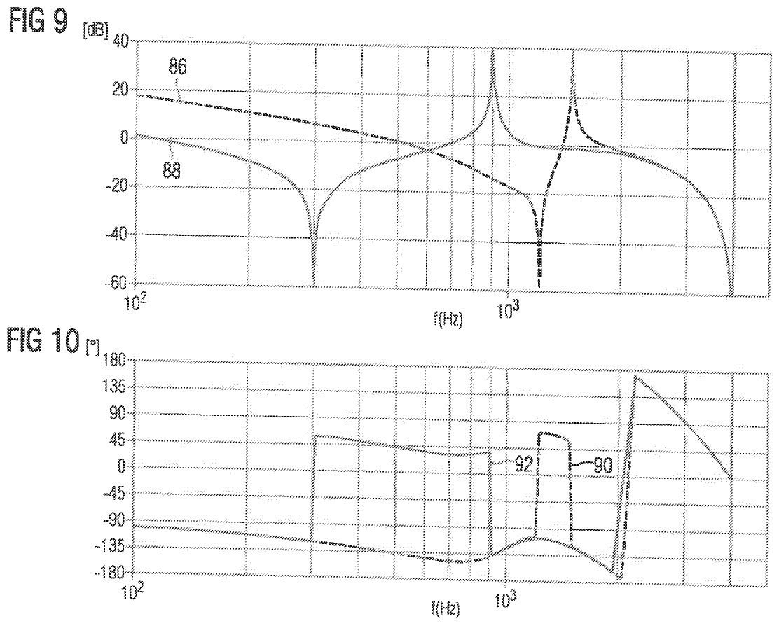

FIG. 9 a schematic diagram as shown in FIG. 7 with the active damping circuit;

FIG. 10 a schematic diagram as shown in FIG. 8 with the active damping circuit;

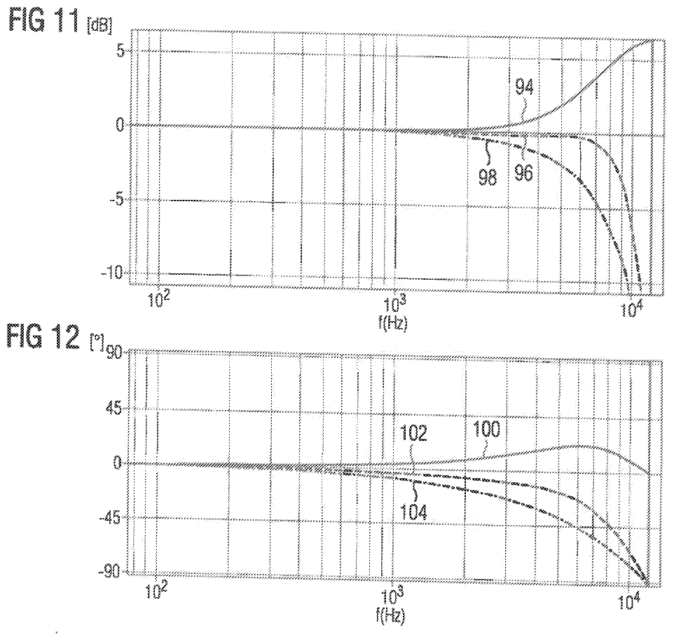

FIG. 11 a schematic diagram as shown in FIG. 5 in which different transfer functions are shown by means of three graphs;

FIG. 12 a schematic diagram as shown in FIG. 6 in which different transfer functions as shown in FIG. 5 are shown by means of three graphs;

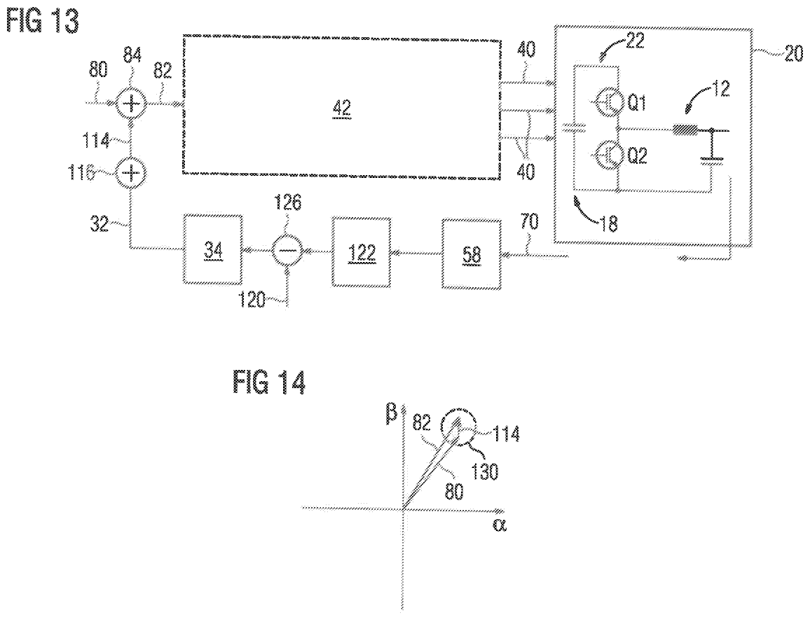

FIG. 13 a schematic block circuit diagram of the active damping circuit in FIG. 4; and

FIG. 14 a schematic diagram of a Clarke transform of a space vector with a superimposed damping space vector.

FIG. 1 is a schematic circuit diagram of an energy converter 10 connected to an alternating voltage grid 14 which has an inverter 20, a filter 12 for electrically coupling the inverter 20 to the alternating voltage grid 14 and a control facility 30. In the present case, the alternating voltage grid 14 provides a three-phase alternating voltage 16 as a multiphase electrical alternating voltage. In alternative embodiments, the alternating voltage can also have a different number of phases.

The energy converter 10 is used to electrically couple the three-phase electrical alternating voltage 16 of the alternating voltage grid 14 to a direct voltage intermediate circuit 18 to which an intermediate circuit direct voltage 28 is applied. The inverter 20 has at least one series circuit 22 comprising switching elements 24 for each of the phases of the three-phase alternating voltage 16. A respective series circuit 22 is electrically connected to the direct voltage intermediate circuit 18. A respective center terminal 26 of a respective series circuit 22 is electrically coupled to a respective phase of the three-phase alternating voltage 16. On the alternating-voltage side, the filter 12 is connected to the inverter 20 via which the electrical coupling of the inverter 20 to the three-phase alternating voltage 16 takes place. A control facility 30 is used, inter alia, to operate the switching elements 24 of the inverter 20 by providing corresponding switching signals 40. In the present embodiment, it is provided that a clock rate for providing the switching signals 40 is approximately 4 kHz. However, in alternative embodiments, the clock rate can also be selected differently from this.

In the illustration in FIG. 1, the alternating voltage grid 14 is symbolically represented by a three-phase alternating voltage source schematically connected in series with a grid inductance L_{grid}. The grid inductance L_{grid} symbolically represents the inductive effect of the alternating voltage grid 14.

In the present case, the filter 12 is embodied as an LCL filter with a T-filter structure and includes a series circuit of two inductances: inductances Lₖ and Lₑ. A terminal provided by the inductance is electrically connected to the alternating voltage grid 14. A terminal provided by the inductance Lk is electrically connected to the respective phase terminals of the inverter 20. In the present case, the inductances L_{grid}, Lₖ, Lₑ are in each case provided for each phase.

Respective center terminals of the series circuits of the inductances Lₖ and Lₑ are connected to a terminal of a respective series circuit comprised of an electrical resistance R_{d} and an electrical capacitance C_{f}. These series circuits are connected to an electrical reference potential 44, which in the present case is a ground potential.

FIG. 2 is a schematic circuit diagram as shown in FIG. 1 in which an electrical current sensor 46 detects an electrical current in a branch of the LCL filter 12, which is formed by the respective series circuit of the electrical resistance R_{d} and the electrical capacitance C_{f}, and provides a corresponding current signal 50 for the control facility 30. This embodiment is provided separately for each phase of the three-phase alternating voltage 16. The current signals 50 of the current sensors 46 are fed to the control facility 30.

FIG. 2 furthermore shows schematically one of the series circuits 22 with its switching elements 24 of the inverter 20 for one of the phases of the three-phase alternating voltage 16. The series circuits 22 are provided for all phases of the three-phase alternating voltage 16. It can be seen that, in the present case, the series circuits 22 are embodied as half-bridge circuits. In the present embodiment, it is further provided that the switching elements 24 are formed by IGBTs. It is obviously also possible for other suitable switching elements to be provided here in alternative embodiments It can also be seen in FIG. 2 that the control facility 30 has a damping regulator 38. The damping regulator 38 is connected to the current sensors 46 and receives the corresponding current signals 50 from the respective current sensors 46. Furthermore, current sensors 54 are provided with which respective phase currents i_{U} of the three-phase alternating voltage 16 can be detected. The current sensors 54 are connected to a field-oriented regulator 36.

The field-oriented regulator 36 ascertains a space vector 80, which is linked to a damping signal 32 of the damping regulator 38 by means of a link 56. This signal is then fed to space vector modulation 42 which provides the switching signals 40 for the switching elements 24, so that the desired switching mode can be achieved by means of the inverter 20.

FIG. 3 is a schematic circuit diagram as shown in FIG. 2 in which, instead of detecting the electrical current by means of the current sensors 46, an electrical filter voltage can be detected for each phase by means of a respective voltage sensor 48 at the respective center terminal of the inductances La and Lx with respect to the reference potential 44. Corresponding voltage signals 52 are again fed to the damping regulator 38. The further structure corresponds to that already explained for FIG. 2 and so reference is also made to the statements made in this regard.

FIG. 4 is a schematic block circuit diagram showing, inter alia, a section of the control facility 30, such as that used in FIG. 1 to FIG. 3. FIG. 4 does not show that the detected intermediate circuit direct voltage 28 is fed via an analog-to-digital converter to an Intermediate circuit regulator (not shown). A comparison value for the intermediate circuit direct voltage 28 is also fed to the intermediate circuit regulator.

Also not shown is that phase voltages of the multiphase alternating voltage 16 are detected and fed by means of a further analog-to-digital converter to a PLL circuit. The PLL circuit provides a phase signal. Detecting the phase voltages is not absolutely necessary during operation as intended and only needs to be performed, for example once, to start operation as intended of the energy converter 10 or the inverter 20.

Finally, phase currents 70 are detected and fed to a current regulator (not shown) by means of a further analog-to-digital converter 58 (FIG. 13), The current sensors 54 can be used for this purpose. The values I_{d,ref}, I_{q,ref} and also the phase signal are fed to the current regulator. The current regulator determines a space vector 80 from the supplied variables. During operation as intended, this field-oriented regulator only requires the intermediate circuit direct voltage in addition to the phase currents. Unlike in the prior art, no further electrical variables, in particular of the filter 12, need to be detected and provided.

It can be seen from FIG. 4 that the space vector 80 is not fed directly to space vector modulation 42, but is fed via a linking circuit 84. The linking circuit 84 links the space vector 80 with a damping space vector 114 in the manner of a vector addition. The damping space vector 114 is used to damp grid-side resonant frequencies during operation as intended of the energy converter 10 or the inverter 20.

The damping space vector 114 is ascertained by means of a signal-space vector converter 116 as a function of a damping signal 32. The damping signal 32 is in turn ascertained as a function of the detected digitized phase currents 70 by a phase shifter circuit 34 as a damping unit. The linking circuit 84 changes the space vector 80 with respect to a phase lead and from this determines a leading space vector 82. The leading space vector 82 is fed to the space vector modulation 42 by means of which the switching signals 40 for the switching elements 24 of the inverter 20 are determined.

It can be seen from FIG. 4 that the field-oriented regulator 36 is based on a field-oriented regulator which is in principle known and so no further detailed explanations will be given in this regard in the present case. The field-oriented regulator 36 is communicatively coupled to a target value register 124, which provides target values for the field-oriented regulator 36 in a known manner. Unlike in the prior art, the space vector 80 according to the invention is not fed directly to space vector modulation 42, it is first further processed by means of the linking circuit 84 before being fed to space vector modulation 42.

It can be seen from FIG. 4 that the detected phase currents 70 are first digitized by means of the analog-to-digital converter 58. For this purpose, in the present case, it is provided that the detected phase currents 70 are digitized by means of a sigma-delta method as an integrating measuring method. Herein, a digitization clock period is at least a factor of 1000 smaller than the clock period of the clock signal. Then, it is provided as part of the digitization that averaging is performed for the detected phase currents 70, which averaging extends over two clock periods of the clock signal. The digitized phase currents 70 are then fed to a Clarke transformation 122. The transformed phase currents are then linked to target values 120 for the phase currents by means of a linking circuit 126. In the present case, a difference is formed and a difference signal 128 is provided. The difference signal 128 is fed to the phase shifter circuit 34. The target values 120 are provided using a block 118 which is communicatively coupled to a target value register 124, which supplies target current values in dq coordinates. The function of the block 118 is known to the person skilled in the art and so no further detailed statements will be made in this regard.

FIG. 13 is an enlarged schematic diagram of a section from FIG. 4 in the area of the phase shifter circuit 34 and the signal processing with respect to the space vector 80. It can be seen that the detected phase currents 70 are converted into digital signals by means of the analog-to-digital converter 58. In the present case, the sigma-delta method is used for the conversion.

In the present case, the digitization clock period used for the sigma-delta method is selected in a range from approximately 10 MHz to approximately 20 MHz. This enables an integrating current measuring method to be provided, which is advantageously suited to reducing harmonics caused by switching operations. The phase currents 70 digitized in this way are fed to the phase shifter circuit 34 whilst forming the difference from the target values 120.

The phase shifter circuit 34 supplies the damping signal 32, which is converted into a damping space vector 114 and linked to the space vector 80 by means of the linking circuit 84, so that the leading space vector 82 can be provided. This is then fed to space vector modulation 42, which determines the switching signals 40 therefrom in a known manner.

In the present case, the phase shifter circuit 34 is embodied as a lead-lag element and enables a phase gain to be achieved. This makes it possible to compensate system-related runtimes, such as those that can occur during PWM, during processing of the signals, detection of sensor values, and/or the like. In addition, a sufficient phase reserve can be created so that resonant frequencies occurring on the alternating voltage side in conjunction with the filter 12 can be actively damped. The filter function of the phase shifter circuit 34 specifies a frequency range in which any resonant frequencies that occur can be damped.

The following further explains the function of the invention with reference to diagrams. The starting point is an energy converter 10, which has the filter 12 and the inverter 20, wherein a clock rate with respect to the provision of the switching signals 40 is approximately 4 kHz. Depending on the grid inductance L_{grid} and thus on a relative grid short circuit voltage or a variable inverted thereto, and namely a relative grid short-circuit power, which in the present case is between approximately 5 and approximately 250, a resonance boost of the overall system, including the alternating voltage grid 14 is approximately between 930 Hz and 1400 Hz in the present example.

This is illustrated by FIG. 7 and FIG. 8, which represent a Bode diagram. An abscissa in the two schematic diagrams in FIG. 7 and FIG. 8 is assigned to the frequency, whereas, in FIG. 7, the ordinate is assigned to an amplitude and, in FIG. 8, the ordinate is assigned to a phase. A graph 86 represents an amplitude curve over the frequency for a relative grid short-circuit power RSC 250, whereas a graph 88 shows an amplitude curve for a relative grid short-circuit power RSC 5. The corresponding phase curves can be seen from the associated schematic phase diagram 8, whereas a graph 90 is assigned to graph 86 and a graph 92 is assigned to graph 88.

The resonance points can be easily recognized from the phase jumps. It can be seen from FIG. 7 and FIG. 8 that the resonant frequency of the filter 12 becomes smaller as the grid inductance Lord increases. Here, the phase gain is significantly smaller or can even become negative. The phase loss can increase due to the system runtimes, particularly at low resonant frequencies. The system runtime, also called dead time, takes into account run times of the loop. With a system runtime, a resonant oscillation can develop or change by an angular change Ao, which depends, inter alia, on the resonant frequency:

$$Δφ = {t}_{dead} * {f}_{resonant}$$

wherein t_{dead} is the system runtime and fᵣₑₛₒₙₐₙₜ is the resonant frequency. To compensate for the system runtime in the loop and to be able to calculate a damping circuit matching the instantaneous phase position of the resonant oscillation, an ideal digital filter would therefore have to perform a corresponding frequency-dependent correction of the phase position of the target voltage. All-pass filters would in principle be suitable for this in terms of their amplitude properties, but do not exhibit suitable phase response properties over the entire frequency range in question of the regulator.

On the other hand, the phase shifter circuit 34, in particular when embodied as a lead-lag element, can achieve the desired adaptation of the phase response or the frequency-dependent phase curve, while at the same time minimizing or avoiding undesirable side effects with respect to an amplitude response or a frequency-dependent amplitude curve.

FIG. 7 and FIG. 8 show the function of the open loop without the phase shifter circuit 34. It can be seen that, at a frequency of approximately 1400 Hz, the frequency response has a phase position of approximately −180°. This loop is therefore unstable in the range of this resonant frequency.

FIG. 9 and FIG. 10 show a schematic Bode diagram corresponding to that shown in FIG. 7 and FIG. 8. In this diagram, the loop is shown with an activated function of the phase shifter circuit 34. As can be seen from graphs 86 to 92, a stable function can be achieved here in the two cases shown, even in the resonant frequency range, because a sufficient phase reserve can be provided.

The following describes design criteria for the phase shifter circuit 34. One design criterion is that a sufficient phase lead should be provided for the highest resonant frequency. In addition, it should preferably be possible to achieve a phase curve that is as linear as possible from the highest resonant frequency to the lowest resonant frequencies, Inter alia, so that the system runtimes can be at least partially compensated. Finally, an amplitude increase, in particular at high frequencies, should be kept as small as possible, preferably approximating all-pass filter behavior. In addition, it is obviously in particular advantageous to reduce system runtimes by correspondingly minimizing the runtime of the entire loop. For this reason, the field-oriented regulator 36, preferably also the space vector modulation 42, is realized as a hardware circuit, in particular a digital hardware circuit, for example in the manner of an ASIC, FPGA or the like.

FIG. 11 and FIG. 12 show a further Bode diagram in schematic form representing a transfer function of the phase shifter circuit 34. The abscisse of the schematic diagrams are assigned to the frequency, whereas, in FIG. 11 the ordinate is assigned to the amplitude and, in FIG. 12, the ordinate is assigned to a phase. Graphs 94, 96, 98 represent three different amplitude curves of the transfer function, while graphs 100, 102 and 104 show correspondingly assigned phase curves of the transfer function.

In the present embodiment it is further provided that, in the present case, discontinuous modulation, also called flat modulation, is realized as space vector modulation 42. This is a variant of space vector modulation in which only two of three phases are switched within a cycle by means of the switching elements. This type of modulation is therefore particularly suitable with grid inverters that are operated at high electrical voltage, in particular at the limit of overload, wherein a reduction in switching losses and an increase in efficiency can be achieved. However, the disadvantage is that a current curve is only symmetrical to a complete pulse period. With the Integrating current detection of the phase currents 70 at a clock rate of 4 kHz, it is advantageous to average over a period of 250 μs. With other types of modulation, however, averaging over a period of 125 μs, i.e. half a period can be sufficient. The longer averaging period that results from this leads to a longer runtime in the damping loop and thus a smaller permissible fluctuation margin or phase reserve in the resonant frequency range and this can result in a smaller stability range in the regulation, in in particular with varying grid parameters.

In particular when the phase shifter circuit 34 is embodied as a lead-lag element, it is again possible to compensate this system-related additional runtime at least partially, as can be seen in FIG. 11 and FIG. 12. Graphs 94 and 100 illustrate this for a phase shifter circuit 34, whereas graphs 98 and 104 represent the function with the aforementioned averaging and graphs 96 and 102 represent a combination of the two aforementioned options. The phase shifter circuit 34 has been parameterized such that, as explained above, the additional averaging can be almost completely compensated and the phase loss based on this can thus be significantly reduced.

The schematic diagrams in FIG. 5 and FIG. 6 show a further Bode diagram, wherein FIG. 5 shows a frequency-dependent amplitude curve and FIG. 6 shows a frequency-dependent phase curve of the transfer function of the phase shifter circuit 34. The abscisse in FIG. 5 and FIG. 6 are again assigned to the frequency. The ordinate in FIG. 5 is assigned to the amplitude and the ordinate in FIG. 6 is assigned to the phase. The filter transfer function of the phase shifter circuit 34 is shown by means of graphs 106 and 110. It can be seen from graphs 108 and 112 that the additional aforementioned filtering or averaging can provide a further improvement in the transfer function for the desired application. In particular, an approximately linear phase increase can be provided in the desired range, as can be seen from the schematic diagram in FIG. 6. This proves to be particularly advantageous for the function.

FIG. 14 is a schematic diagram showing the relationship of the space vectors 80, 82, 114 as Clarke transforms. It can be seen that the space vector 82 is formed from a vector addition of the space vector 80 and the damping space vector 114. Herein, it can be seen that the space vector 80 has a significantly lower frequency than the damping space vector 114. This means that, during a comparatively slow rotation of the space vector 80, a fast rotation of the damping space vector 114 is superimposed. This is represented by a circle 130 in FIG. 14. This also clearly Illustrates the effect of the invention. If no resonant frequency occurs, there is substantially no significant damping space vector 114 due to the function of the damping unit. If, on the other hand, a resonant frequency occurs, the phase shifter circuit 34 or the damping unit provides a suitable damping space vector 114, which makes it possible to counteract the resonance.

Overall, the following can be achieved with the invention if it is interpreted appropriately:

Active damping can be achieved without additional measured variables because the phase shifter circuit 34 only requires the phase currents 70 that would be detected anyway for the operation of the inverter 20 as intended. In particular, there is no need for separate phase voltages to be permanently detected.

In addition, only the phase shifter circuit 34 needs to be provided. In particular no model or observer needs to be introduced into the loop. Incidentally, this component would require at least partial knowledge of parameters of the alternating voltage grid 14 and thus reduce the stability of the regulator with respect to variations in these unknown parameters. Furthermore, the entire loop can be integrated into a circuit, such as an ASIC, FPGA or the like. This integrated circuit should preferably further comprise measured value detection and/or measured value processing and the current regulator, a phase-compensated digital filter, preferably a second order filter and the calculation of switching operations in the space vector modulation 42. Furthermore, integrating detection of the phase currents, in particular according to a sigma-delta method, can preferably be used to suppress, for example, radio-frequency interfering frequency components in the current measurement. Finally, discontinuous pulse width modulation (PWM) can preferably be used to minimize power loss and to compensate the resulting run times using, for example, higher order digital filters in the modulator.

The invention makes it possible for only the phase currents 70 in the inverter 20 to be required as measured values. In particular, no external currents and voltages, for example from a grid filter or the grid need to be taken into account.

In particular, no precise knowledge of current grid parameter values is necessary in a wide range of grid properties. The regulator according to the invention is robust against changes in grid properties; these do not need to be known.

Furthermore, the loop does not require bandpass filters or stop filters whose blocking frequency would have to be precisely adapted to the current grid properties.

Even though, in the present case, the invention is explained with reference to an application with three-phase alternating voltage as a multiphase alternating voltage, the invention is not restricted thereto; it can be used with any multiphase alternating voltages for example four-phase, five-phase, or six-phase alternating voltages.

The exemplary embodiments serve solely to explain the invention and are not intended to restrict it.

1-12. (canceled)

13. A method for operating switching elements of an inverter which is electrically coupled to a multiphase alternating voltage of an alternating voltage grid via an alternating voltage-side filter, wherein the inverter has at least one series circuit comprised of the switching elements for each phase of the multiphase alternating voltage in order to electrically couple the multiphase alternating voltage to a direct voltage intermediate circuit connected to the inverter, the method comprising:
detecting phase currents of phases of the multiphase alternating voltage and an intermediate circuit direct voltage;
ascertaining a space vector solely as a function of the detected phase currents and the detected intermediate circuit direct voltage based on a field-oriented regulator;
determining a damping signal as a function of the detected phase currents, so that phase positions of target phase voltages are shifted by a specified phase value with respect to at least one specified frequency which is greater than a fundamental oscillation of phase voltages of the multiphase alternating voltage;
ascertaining a damping space vector as a function of the damping signal;
determining switching signals as a function of the space vector by space vector modulation and using the target phase voltages, by superimposing the damping space vector on the space vector, and based on a clock signal using pulse width modulation, wherein a clock period of the clock signal is smaller than an oscillation period of the fundamental oscillation; and
applying the switching signals to the switching elements of the series circuits,

14. The method of claim 13, wherein the phase positions exhibit lead shifting.

15. The method of claim 13, further comprising providing the damping signal by a damping unit which determines the at least one specified frequency, evaluates the phase currents, and ascertains the phase value as a function of the evaluation.

16. The method of claim 13, further comprising digitizing the detected phase currents by an integrating measuring method.

17. The method of claim 13, further comprising using discontinuous pulse width modulation as pulse width modulation.

18. The method of claim 13, further comprising averaging the detected phase currents, which averaging extends over at least two clock periods of the clock signal.

19. The method of claim 13, further comprising detecting the phase currents in respective detection periods, wherein a respective one of the detection periods extends over a respective clock period of the clock signal.

20. The method of claim 13, further comprising detecting the phase voltages of the multiphase alternating voltage before the space vector is ascertained, and initializing the field-oriented regulator as a function of voltage signals corresponding to the phase voltages.

21. The method of claim 13, further comprising using a transfer function provide the damping signal, which transfer function has an amplification factor in a range of 1, at least in the range of the at least one specified frequency.

22. A control facility for operating switching elements of an inverter which is electrically coupled to a multiphase alternating voltage of an alternating voltage grid via an alternating voltage-side filter, wherein the inverter has at least one series circuit comprised of the switching elements for each of the phases of the multiphase alternating voltage, the control facility configured to:
detect phase currents of phases of the multiphase alternating voltage and an intermediate circuit direct voltage,
ascertain a space vector solely as a function of the detected phase currents and the detected intermediate circuit direct voltage based on a field-oriented regulator,
determine a damping signal as a function of the detected phase currents, so that phase positions of target phase voltages are shifted by a specified phase value with respect to at least one specified frequency which is greater than a fundamental oscillation of phase voltages of the multiphase alternating voltage,
ascertain a damping space vector as a function of the damping signal,
determine switching signals as a function of the space vector by space vector modulation and using the target phase voltages, by superimposing the damping space vector on the space vector, and based on a clock signal using pulse width modulation, wherein a clock period of the clock signal is smaller than an oscillation period of the fundamental oscillation, and
apply the switching signals to the switching elements of the series circuits.

23. The control facility of claim 22, further comprising a phase shifter circuit providing the damping signal.

24. An energy converter for electrically coupling a multiphase electrical alternating voltage of an alternating voltage grid to a direct voltage intermediate circuit, the energy converter comprising:
an inverter which has at least one series circuit comprising switching elements for each of the phases of the multiphase alternating voltage, wherein a respective series circuit is electrically coupled to the direct voltage intermediate circuit and a respective center terminal of a respective series circuit is electrically coupled to a respective phase of the multiphase alternating voltage;
an alternating voltage-side filter electrically coupling the inverter to the multiphase alternating voltage; and
the control facility of claim 22 operating the switching elements of the inverter.
